(19) United States
(12) Patent Application Publication
(10) Pub. No.: US 2015/0369465 A1
(43) Pub. Date: Dec. 24, 2015

(54) LIGHTING SYSTEM

(71) Applicant: RSI Development LLC, Anaheim, CA (US)

(72) Inventor: John Du, Hacienda Heights, CA (US)

(21) Appl. No.: 14/743,686

(22) Filed: Jun. 18, 2015

Related U.S. Application Data
(60) Provisional application No. 62/014,590, filed on Jun. 19, 2014.

(51) Int. Cl. F21V 23/02; F21V 29/74; F21V 15/01; F21V 7/22; F21S 8/02; F21V 21/04

(52) U.S. Cl. CPC F21V 23/026; F21S 8/026; F21V 21/047; F21V 15/01; F21V 7/22; F21V 29/74; F21Y 2101/02

(57) ABSTRACT

Disclosed herein are embodiments of a lighting system, and a method of installation, which can be advantageous over lighting systems of the prior art. The lighting system may not have a can covering its components, thus allowing for the lighting system to be easily installed and have a reduced footprint. The disclosed lighting system can be installed as retrofit lighting for a building.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is generally related to a lighting system and in particular, to a lighting system that can easily be installed in a building.

### SUMMARY

Disclosed herein are embodiments of a lighting system comprising a housing configured to hold at least one source of illumination at a front end, at least one clip configured to rotatably attach to the housing, and a junction box having a closed end attached to a back end of the housing opposite the front end, the junction box sized and configured to hold electronic components for operating the source of illumination, wherein the housing and junction box are not covered by a can.

In some embodiments, there is no separate arm. In some embodiments, there is no mounting slide. In some embodiments, the housing can be generally circular. In some embodiments, the at least one source of illumination can comprise at least one LED. In some embodiments, the electronic components can comprise a transformer and wires. In some embodiments, the junction box can be open opposite the closed end. In some embodiments, the at least one clip can be spring mounted to the housing.

In some embodiments, the electronic components can comprise a hot potted transformer. In some embodiments, the at least one source of illumination can be removable from the hot potted transformer. In some embodiments, the housing can comprise at least one fin extending radially away from the base portion. In some embodiments, the lighting system can have a total height of 5 inches or less.

In some embodiments, the junction box can comprise a plurality of walls extending from the closed end to the back end and configured to hold the electronic components. In some embodiments, the plurality of walls can comprise at least one cord retainer configured to accept and retain a cord.

In some embodiments, the housing can comprise a baffled surface. In some embodiments, the housing can comprise a reflector surface. In some embodiments, said housing can act as a heat sink. In some embodiments, said housing can act as a heat sink and can have a thermal resistance of at least 2.75° C. per watt.

In some embodiments, the lighting system can further comprise a dwelling comprising a ceiling wherein said housing is supported by said ceiling. In some embodiments, said ceiling can comprise drywall and wherein said housing is supported by said drywall. In some embodiments, wherein said housing can be spaced from any radially surrounding structure having vertical surrounding metal walls by at least 12 inches.

Disclosed herein are embodiments of a lighting system comprising a housing configured to hold at least one source of illumination at a front end of the housing, a junction box having a closed end supported by a back end of the housing opposite the front end, the junction box holding at least one electronic component for operating the source of illumination, and a transformer supported by the housing, wherein the housing and junction box are not covered by a can.

In some embodiments, the system can further comprise at least one clip rotatably attached to the housing. In some embodiments, the at least one clip can be spring mounted to the housing.

In some embodiments, there is no separate arm attached to the housing. In some embodiments, there is no mounting slide configured to attach to the housing.

In some embodiments, the housing can have a generally circular cross section. In some embodiments, the at least one source of illumination can comprise at least one LED.

In some embodiments, the junction box can be open opposite the closed end. In some embodiments, the transformer can comprise a hot potted transformer. In some embodiments, the housing can comprise at least one fin extending radially away from the base portion. In some embodiments, the system can further comprise a spacer located between and attached to the housing and junction box. In some embodiments, the lighting system can have a total height of 5 inches or less.

In some embodiments, the junction box can comprise a plurality of walls extending from the closed end to the back end and configured to hold the electronic components. In some embodiments, the plurality of walls can comprise at least one cord retainer configured to accept and retain a cord.

In some embodiments, the housing can comprise a baffled surface. In some embodiments, the housing can comprise a reflector surface. In some embodiments, said housing can be spaced from any radially surrounding structure having vertical surrounding metal walls by at least 12 inches.

Also disclosed herein are embodiments of a lighting system comprising a housing configured to hold at least one source of illumination at a front end of the housing and a junction box having a closed end supported by a back end of the housing opposite the front end, the junction box holding a transformer for operating the source of illumination. In some embodiments, the housing and junction box are not covered by a can.

Also disclosed herein are embodiments of a method of installing a lighting system into a building, the method comprising cutting an aperture in a building surface, attaching a lighting system to a power source in the building, the lighting system comprising a housing configured to hold at least one source of illumination at a front end of the housing, a junction box having a closed end supported by a back end of the housing opposite the front end, the junction box holding at least one electronic component for operating the source of illumination, and a transformer supported by the housing, wherein the housing and junction box are not covered by a can, and inserting the housing, transformer, and junction box into the aperture, wherein the housing, transformer, and junction box are located within the aperture or behind the building surface.

### BRIEF DESCRIPTION OF THE DRAWINGS

FIGS. 1A-C illustrate a first lighting system of the prior art.

FIG. 2 illustrates a second lighting system of the prior art.

FIG. 3 illustrates a clip used in the prior art shown in FIG. 2.

FIGS. 4A-B illustrate an embodiment of the disclosed lighting system.

FIGS. 5A-B illustrate a clip mechanism for an embodiment of the disclosed lighting system.

FIG. 6A illustrates an embodiment of the disclosed lighting system having a spacing component.

FIG. 6B illustrates an embodiment of a spacing component for the disclosed lighting system.

FIGS. 6C-E illustrates an embodiment of the disclosed lighting system having a spacing component.

FIGS. 7A-B illustrate an embodiment of the disclosed lighting system showing the illumination source.

FIG. 8 illustrates the back of an embodiment of a housing without the junction box.

FIG. 9 illustrates a building having installed an embodiment of the disclosed lighting system.

### DETAILED DESCRIPTION

Disclosed herein are embodiments of a lighting system that have numerous and significant advantages over other lighting systems that are used in the prior art. For example, embodiments of the disclosed lighting system can be significantly smaller and more maneuverable than lighting systems in the prior art, making the disclosed lighting system advantageous for installation, removal, and replacement in buildings. Thus, the disclosed lighting system can be easier to install, and thus less complicated for a user. Further, embodiments of the disclosed lighting system can have a significantly longer life than the lighting systems of the prior art.

Embodiments of the disclosed lighting system can be configured to be canless, unlike the configuration used in the prior art which includes a can (e.g., a canister light or recessed can), as discussed below. As used herein, the can of the prior art can be a structure that can be attached to the outer rim of a light structure and can fully surround a back portion of a light structure, which may include other electrical components such as transformers of junction boxes. The cans of the prior art are typically over 2 times the height of the light portion, thus taking up a significant amount of space. The can is typically open on the end that is attached to the back portion of the light structure, and part of the light structure protrudes into the can.

On the other hand, embodiments of the disclosed lighting system can generally include a junction box attached to back of a light structure, and thus no can is used. This can allow for the light structure to fit in smaller places, as well as having less of an overall footprint. The junction box can be, for example, a standard junction box used in the art. In some embodiments, the junction box can have a surface with an aperture (for wires) that can be attached to the back portion of the light structure. This is unlike the can, which merely has an edge surrounding an opening of the can attached to the light structure. Further, unlike the can of the prior art, the light structure does not protrude into the junction box, but instead the junction box sits atop the light structure.

### Prior Art Lighting System

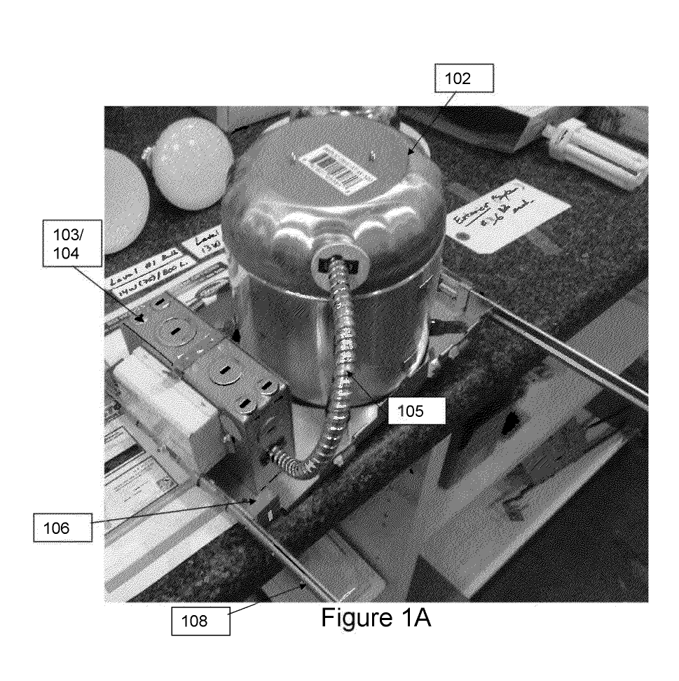

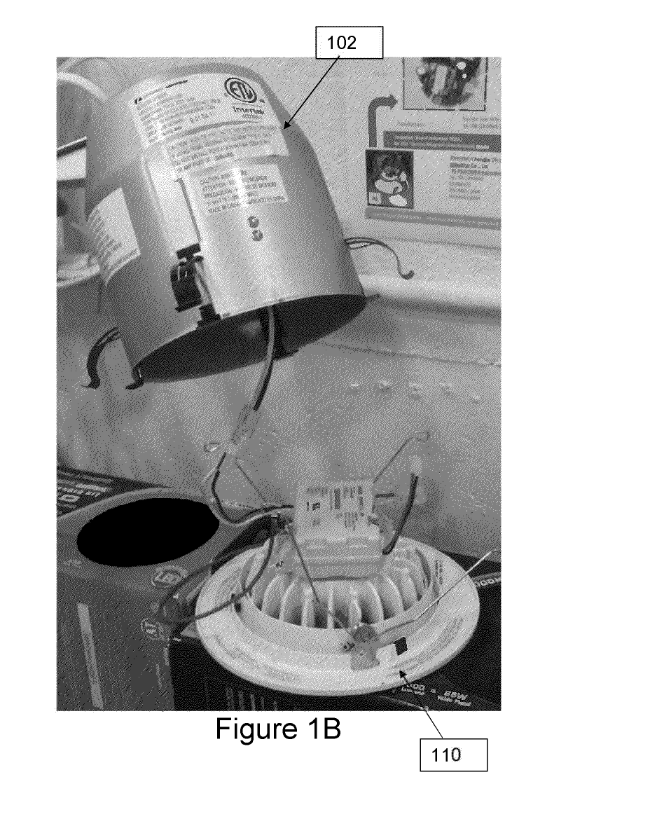

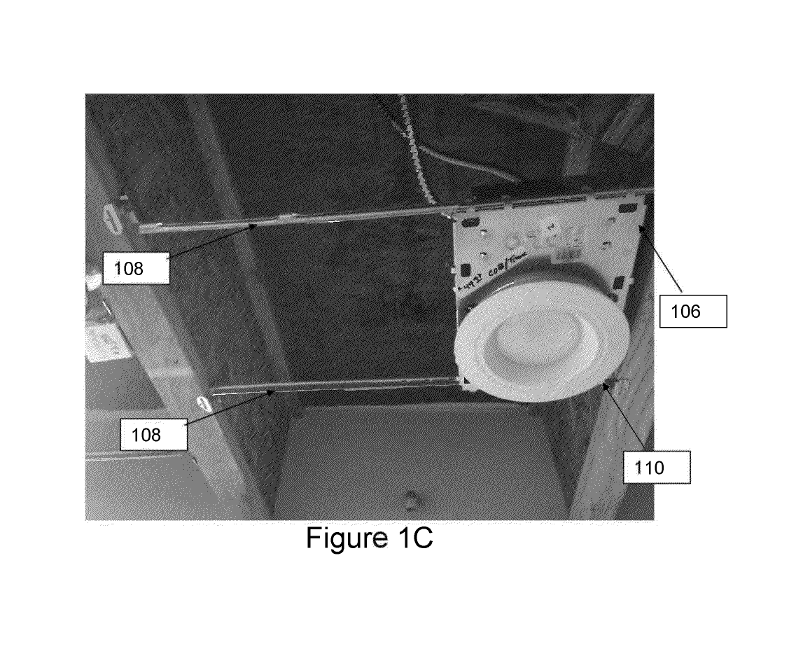

FIGS. 1A-C illustrate a lighting system of the prior art, typically used when installing lighting in a new building. As shown in FIG. 1A, the light is mounted within a can 102. The can 102 is then connected by a conduit 105 to a transformer 104 within a junction box 103, and/or other electrical equipment, and both the can 102 and transformer 104 are mounted onto a mounting slide 106 with rail arms 108. As shown, the mounting slide 106 can be significantly bigger than the can 102 containing the light. In fact, the slide 106 has a width of approximately 2-3 times that of the can 102, thereby taking up a significant amount of room.

FIG. 1B illustrates the prior art lighting system with the light portion 110 removed from the can 102. As shown, the can contains an open end into which the light portion 110 is inserted.

FIG. 1C illustrates the prior art lighting system as it would be attached within a building. As shown, due to the use of mounting slide 106 with rail arms 108, the lighting system can take up a significant amount of physical space. The rail arms 108 can extend at least about 2, 3, or 4 times the size of the slide 106, which itself is substantially bigger than the can 102. This configuration can be disadvantageous as the extended arms 108 makes maneuvering and placement of the prior art lighting system difficult. Sufficient space is needed to install not just the light, but the light, mounting slide 108 and rail arms 108. Further, there needs to be adequate space to turn the rail arms 108 in order to fit the lighting system as necessary. This can lead to the need for a significant spatial footprint when installing the prior art lighting system.

In order to install the prior art lighting system, sufficient space needs to be made available in order to fit both the mounting slide 106 and rail arms 108. This can be difficult, as there may not be such available space in, for example, the ceilings of buildings. The rail arms 108 can prevent rotation of the prior art lighting system. Therefore, the prior art lighting system may not be able to be installed near joints or walls, reducing the applicability of the lighting system. A user may then have to install the lighting system at an awkward or disfavored position.

Further, due to the large size of the prior art lighting system, portions of the ceiling may need to be removed and then reinstalled after installation of the prior art lighting system. This can lead to significant time costs, as well as physical labor. In addition, building owners may not be able to perform this procedure themselves, and may be required to hire a more knowledgeable person for the installation, thus leading to time and money being spent.

In addition, as shown in FIG. 1C, the rail arms 108 are not sized and shaped for high strength application. Accordingly, there is the potential to bend, or break, the rail arms 108 during installation. Further, the rail arms 108 need to be screwed, bolted, or otherwise fastened to more stable portions of the wall, as shown in FIG. 1C. Therefore, the rail arms 108 need to be properly aligned in a building for optimal support. This leads to an excess of time and difficulty in installing the prior art lighting system.

Further disadvantages of the prior art lighting system are that it requires the use of a metallic can 102 around the light portion 110. The can 102 is a significant source of bulk, and thus reduces the locations that the lighting system can be used. Additionally, when the lighting system is operating, the can 102 can become extremely hot. This can be dangerous for users looking to remove or install the lighting system, as they could burn themselves on the can 102. In addition, the excess of heat in the cans leads to a lower operational life of the lighting system, and can drastically reduce the lifetime of the illumination source in the lighting system.

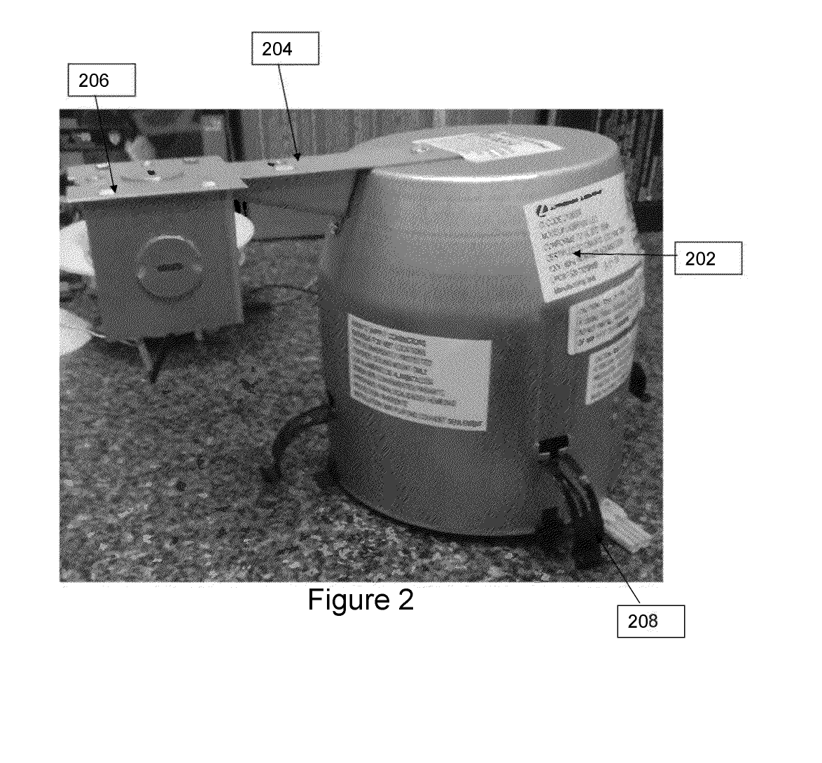

FIG. 2 illustrates another prior art lighting system, typically used for retrofitting a building structure. Similar to the prior art lighting system shown in FIGS. 1A-C, this lighting system also has a metallic can 202 surrounding the lighting portion. Therefore, the same disadvantages with the can as discussed above can also apply to this prior art lighting system.

Additionally, the prior art system contains a solid arm 204, wherein the arm 204 can incorporate a box 206 radially placed from the can 204. As shown, the arm 204 extends radially outward from the can 202 to a distance approximately 2 times the width of the can 202. Thus, as shown in FIG. 2, the width of the prior art can be approximately 2 times the width of the can 202 due to the arm 204. Further, the arm 204 is rigidly attached to the side of the can 202. Similar to the prior art described above with respect to FIGS. 1A-C, the can 202 and arm 204 makes the prior art lighting system difficult to install in a building.

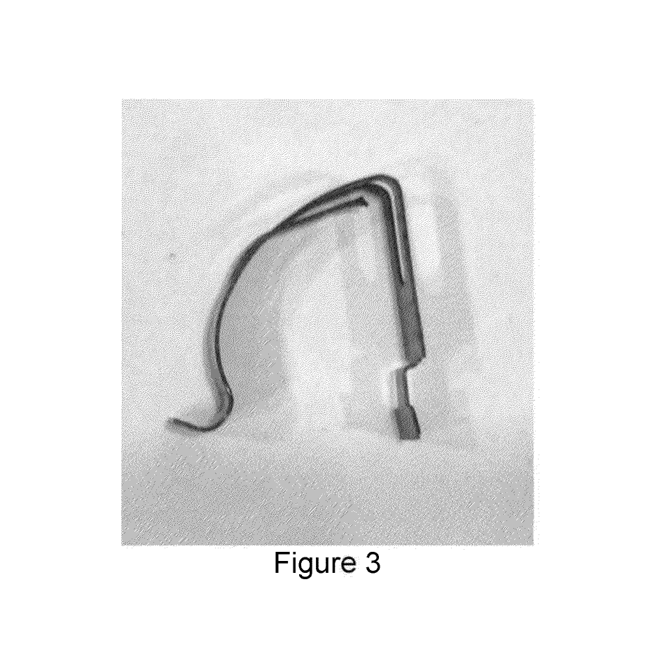

Further, the prior art lighting system shown in FIG. 2 requires the use of series of clips 208 to install the can 202, shown in more detail in FIG. 3. The clip 208 needs to be manually inserted into itself, and can require a substantial amount of dexterity to close the clip 208. Further, the clip 208 must exactly fit into the drywall. This may be difficult as drywall can be too thick for certain clips or too thin for certain clips. Further, drywall may vary in thickness, and thus a clip useful at one location may be useless at a second location. Additionally, the clips 208 are prone to breakage.

Accordingly, installing the prior art lighting system can be exceedingly difficult, and a simpler attachment system would be advantageous.

### Canless Lighting System

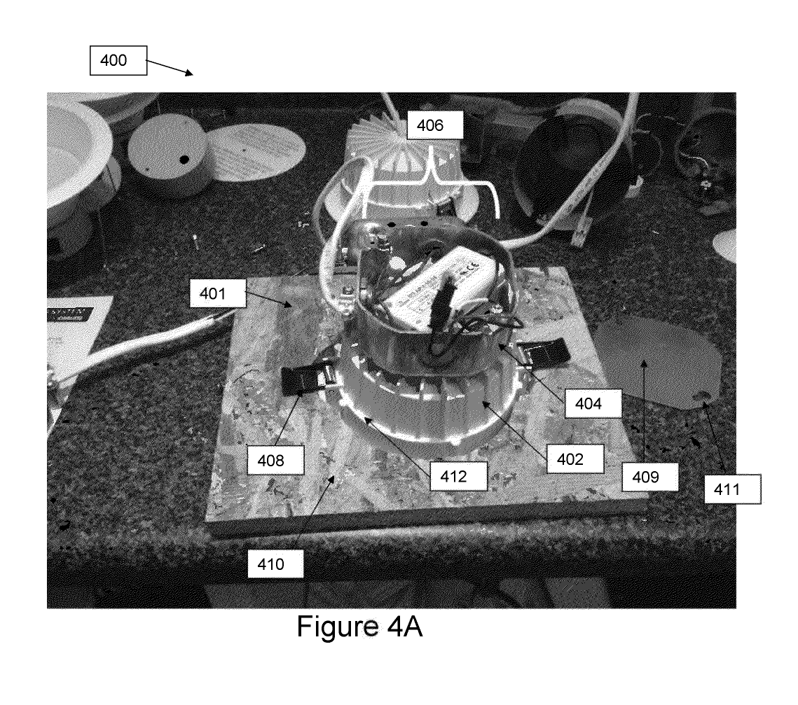

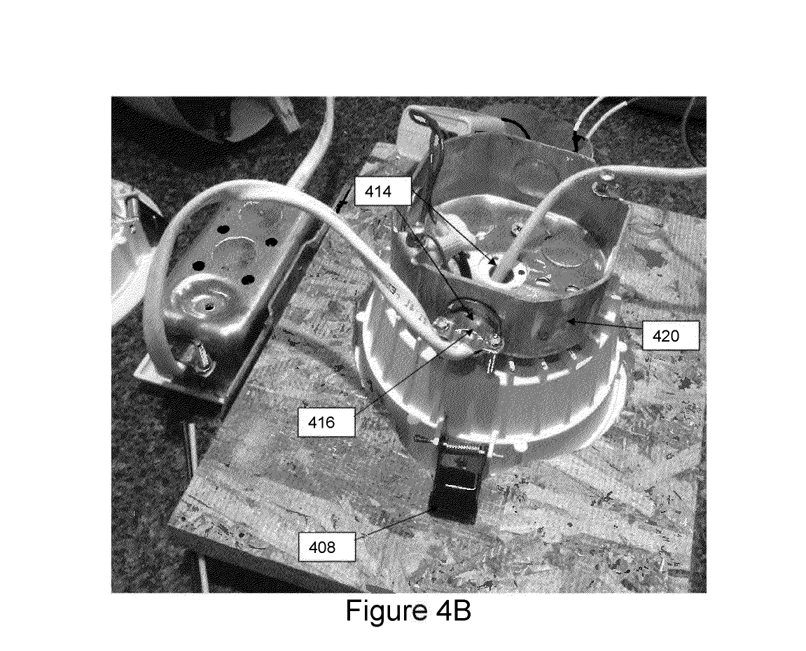

Disclosed herein is an embodiment of a lighting system that can be advantageous over lighting systems in the prior art. FIGS. 4A-B illustrates an embodiment of such a lighting system.

As shown in FIG. 4A, embodiments of the lighting system 400 can be made up of a lighting assembly 401 including a housing 402 and a junction box 404. The housing 402 and junction box 404 can be attached to one another through, for example, screwing or adhesion, though the type of attachment does not limit the disclosure. In some embodiments, the junction box 404 can be supported by the housing 402. The supporting of the junction box 404 by the housing 402 can be direct or indirect, such as having a component, or a plurality of components, between the junction box 404 and the housing 402. In some embodiments, such as the illustrated embodiment, the junction box is directly supported by the housing and is secured directly thereto by a fastener, such as a screw.

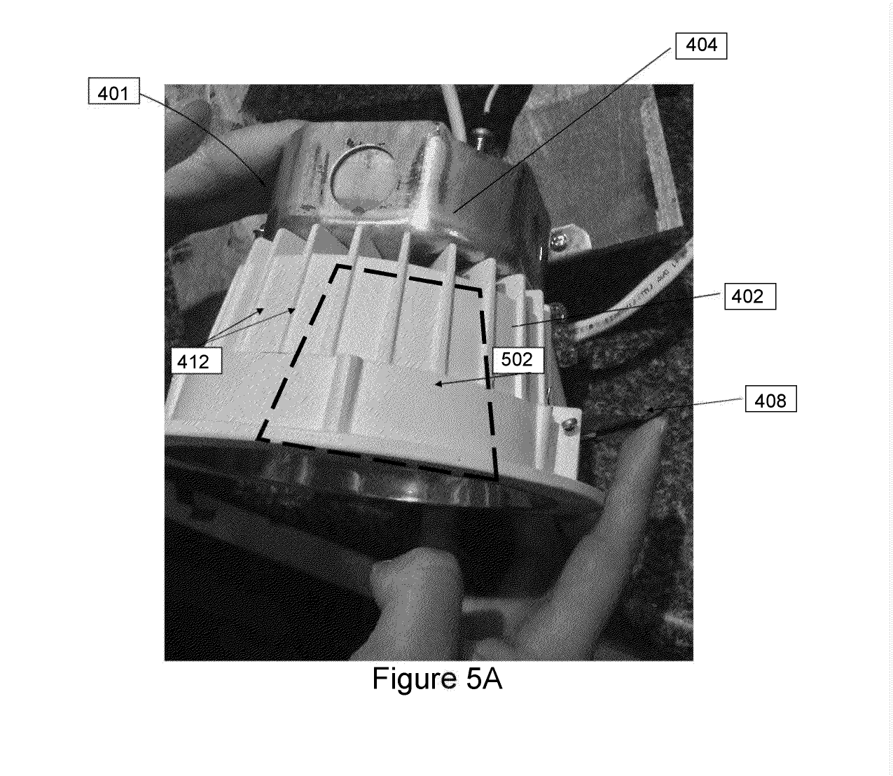

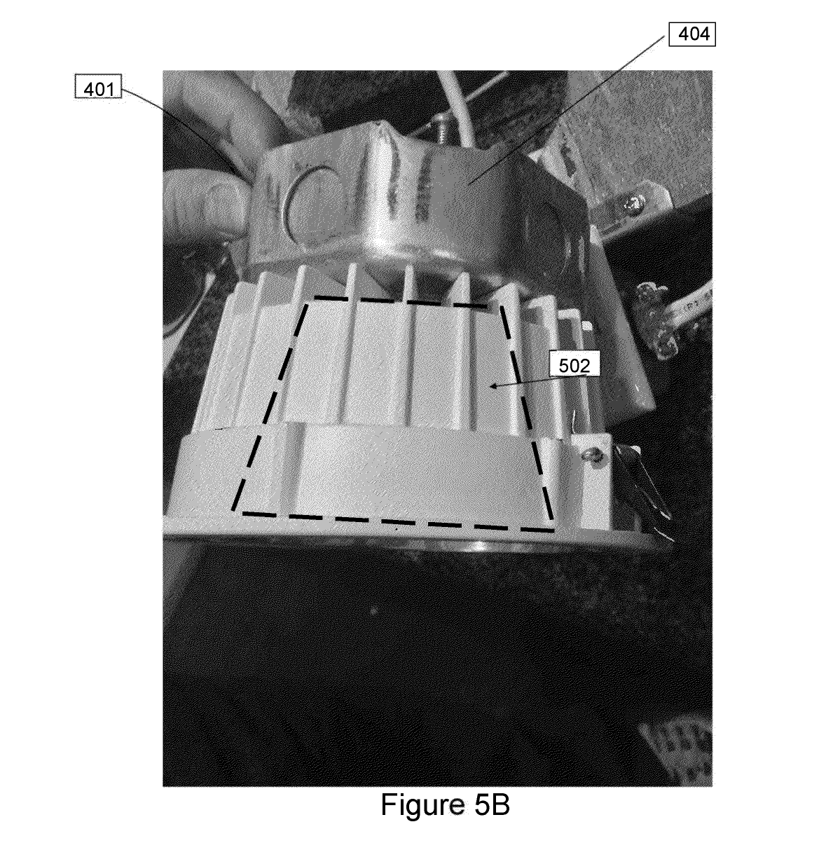

The housing 402 can be sized and configured to retain an illumination source 502 (shown in FIGS. 5A-B and 7A-B). In some embodiments, the housing 402 can be generally disc shaped and/or can define a substantially circular or circular horizontal cross- section, though the shape of the housing 402 does not limit the disclosure. In some embodiments, the housing 402 can have a substantially planar surface upon which the junction box 404 can be mounted. In some embodiments, the housing 402 can have a surface or surfaces that are generally in a single plane in which the junction box 404 can be mounted. For example, edges of the fins 412, discussed below, can all be on the same plane to form a series of surfaces on which the junction box 404 can be mounted. In some embodiments, the housing 402 can define a plug or socket into which the illumination source 502 can be inserted into. In some embodiments, the housing 402 can be configured so that the illumination source 502 is recessed from the bottom of the housing 402 or does not extend outside of the housing 402. The housing 402 can have decorative trim, and can have different aesthetics that can be viewed by a user. The housing 402 can be made of, for example, aluminum or other metal, plastic, or ceramic and the type of material does not limit the disclosure. The illumination source 502 can be, for example, incandescent lights, fluorescent lights, halogen lights, or LED lights, and the type of illumination source does not limit the disclosure.

In some embodiments, the housing can be about 1, 1.25, 1.5, 1.75, 2, 2.25, 2.5, 2.75, 3, 3.25, 3.5, 3.75, or 4 inches tall. In some embodiments, the housing can be greater than about 1, 1.25, 1.5, 1.75, 2, 2.25, 2.5, 2.75, 3, 3.25, 3.5, 3.75, or 4 inches tall. In some embodiments, the housing can be less than about 1, 1.25, 1.5, 1.75, 2, 2.25, 2.5, 2.75, 3, 3.25, 3.5, 3.75, or 4 inches tall.

In some embodiments, the housing 402 can have a plurality of fins 412 on the outside. In some embodiments, there can be 15, 20, 25, 30, or 35 fins surrounding the housing 402. In some embodiments, there can be greater than 15, 20, 25, 30, or 35 fins surrounding the housing 402. In some embodiments, there can be less than 15, 20, 25, 30, or 35 fins surrounding the housing 402. The fins can be advantageous as they can dissipate heat from the illumination source 502 within the housing 402 by, for example, increasing the surface area of the housing 402. In some embodiments, the housing 402 can contain at least one baffled surface, which can allow for improved heat dispersion. In some embodiments, the housing 402 can have a reflecting surface, wherein the reflecting surface can be illuminated by the illumination source 502. However, in some embodiments the housing 402 may not have a heat dissipation surface, and can be generally smooth.

In some embodiments, the housing 402 can act as a heat sink for the lighting system 400. Desirably, the heat sink is at least 0.50 kilograms and is desirably between 0.45 and 0.60 kilograms. Desirably the heat sink has a thermal resistance of at least 2.75, 3.00, 3.25, 3.5, 3.75, or 4.00° C. per Watt.

As mentioned above, the housing 402 can have a plurality of fins 412. The housing material, e.g. aluminum in some embodiments, mass, spacing of the fins 412, and thickness of each fin 412 can allow for the dissipation of heat. As a result of the reduced heat, the disclosed lighting system 400 can consume much less energy than the prior art, while still providing excellent light quality, and can improve lifetime. Further, the housing 402 is additionally not surrounded by a separate other housing (e.g., a can), unlike those in the prior art. Desirably, the housing is spaced from any radially surrounding structure having vertical surrounding metal walls by at least 12 inches.

FIG. 4B illustrates an embodiment of the lighting system 400 where the electronic components 406 are partially removed from the junction box 404. As shown, the junction box 404 can be generally hollow, having walls 420 that can surround and contain the electronic components 406. In some embodiments, the cross-sectional shape of the junction box 404 when viewed from above when installed in a horizontal ceiling can be generally square, though the shape does not limit the disclosure, and other shapes such as circles, rectangles, and ovals can be used. In some embodiments, the junction box 404 can have similar dimensions to the housing 402. In some embodiments, the walls 420 of the junction box 404 can be about 1, 2, 3, 4, or 5 inches tall. In some embodiments, the walls 420 can be greater than about 1, 2, 3, 4, or 5 inches tall. In some embodiments, the walls 420 can be less than 3, 4, 5, 6, 7, or 8 inches tall. Further, the junction box 404 can have at least one aperture 414 for cords and/or wires to pass through, allowing for electrical communication into and out of the junction box 404. The aperture 414 can be used to communicate electrical power from an outside power source, such as a wall outlet, though the source does not limit the disclosure. The power source can be communicated through the junction box 404 and into the housing 402, thereby activating the illumination source 502 retained within the housing 402. In some embodiments, a plurality of apertures can be formed in the junction box 404. In some embodiments, the junction box 404 can be structured to be in compliance with the National Electric Code (NEC).

In some embodiments, the junction box 404 does not extend radially more than ½, ⅓, ¼, ⅕, or ⅙ of the width of the junction box 404 beyond the width of the housing 402. In some embodiments, the junction box 404 does not extend at all radially beyond the width of the housing 402.

The junction box 404 can be sized and configured to fit any electronic components 406 to be used in the lighting system. This can include, for example, transformers 405, wires 407, batteries, and the types of electronic components 406 does not limit the disclosure. In some embodiments, the junction box 404 can be formed of a metal, though the type of material does not limit the disclosure. In addition, the lighting system can have at least one clip 408 for securing the lighting system to a building structure 410 such as, for example, a building celling, which is discussed in detail below.

Advantageously, in some embodiments a transformer 405, for example a transformer for converting voltage to LED voltage, can be contained within the junction box 404, that is located within the circumference of the housing 402. This can allow for lower power illumination sources, such as LEDs, to be used with embodiments of the lighting system. This can lead to a significant reduction in power used, and can thus provide energy savings. In some embodiments, the transformer 405 can be hot-potted for the reduction of heat. The transformer 405 can be hot potted according to IP67, IP65, and/or IP30 Standard, each of which is hereby incorporated by reference in its entirety. In some embodiments, the transformer 405 can be a UL Class #2 approved 15 watt and/or 16 watt, with input of 90-305V, and output of 24V DC, though the type of transformer does not limit the disclosure. In some embodiments, the transformer 405 can also be removably attached to the illumination source 502 through wires 407, thereby allowing the illumination source 502 to be removed and replaced without removing the entire lighting system.

In some embodiments, the junction box 404 can define an open end opposite the housing 402. In some embodiments, a cover 409 can be used to cover the open end of the junction box 404. The cover 409 can be generally sized and shaped to essentially completely cover the junction box 404, thereby securing in the electronic components 406 in the junction box 404. In some embodiments, the cover 409 can be made of the same material as the junction box 404. In some embodiments, the cover 409 can be made of a different material than the junction box 404. In some embodiments, the cover 409 can include at least one aperture 411, thus allowing for wires to enter and exit the junction box 404. In some embodiments, side of the junction box 404 can include an aperture for wires. In some embodiments, the cover 409 can be flexible to allow the cover 409 to be partially pulled away from the junction box 404 to form an aperture for wires to pass through. In some embodiments, the cover 409 may be screwed onto the junction box 404.

Further, in some embodiments the junction box 404 can have a cord retainer 416, such as a wiring clamp, located on at least one of the walls 420, though the location of the cord retainer 416 does not limit the disclosure. The cord retainer 416 can surround an aperture 414 in the junction box 404. A cord can be inserted into the aperture 414 and through the cord retainer 414 and held in place, and the means for holding the cord does not limit the disclosure. The cord retainer 416 can be used to prevent a cord from pulling out of the junction box 404, as is required by some building codes. The cord retainer 416 can be, for example, a clamp connector, such as a twin-screw cable clamp connector, though the type of retainer 416 does not limit the disclosure.

In some embodiments, the lighting assembly 401 can be about 1, 2, 3, 4, 4.25, 5, 6, 7, 8, 9, 10, 11, or 12 inches tall. In some embodiments, the lighting assembly 401 can be greater than about 1, 2, 3, 4, or 5 inches tall. In some embodiments, the lighting assembly 401 can be less than 4, 5, 6, 7, 8, 9, 10, 11, or 12 inches tall. In some embodiments, the lighting assembly 401 can be about 1, 2, 3, 4, 5, 6, 7, 8, 9, 10, 11, or 12 inches wide. In some embodiments, the lighting assembly 401 can be greater than about 1, 2, 3, 4, or 5 inches wide. In some embodiments, the lighting assembly 401 can be less than 4, 5, 6, 7, 8, 9, 10, 11, or 12 inches wide. In some embodiments, the lighting assembly 401 can weigh about 0.5, 0.6, 0.7, 0.75, 0.8, 0.9, or 1 kg. In some embodiments, the lighting assembly 401 can weigh less than about 0.5, 0.6, 0.7, 0.75, 0.8, 0.9, or 1 kg. In some embodiments, the lighting assembly 401 can weigh greater than about 0.5, 0.6, 0.7, 0.75, 0.8, 0.9, or 1 kg. In some embodiments, the lighting assembly 401 can use 12W of power. In some embodiments, the lighting assembly 401 can output 24V.

In some embodiments, the lighting assembly 401 can produce about 700, 720, 740, 760, 780, or 800 lumens. In some embodiments, the lighting assembly 401 can produce greater than about 700, 720, 740, 760, 780, or 800 lumens. In some embodiments, the lighting assembly 401 can produce less than about 700, 720, 740, 760, 780, or 800 lumens.

FIGS. 5A-C illustrate a side view of the lighting assembly 401. As shown, the clip 408 can be in the open (FIG. 5A) and closed (FIG. 5B) positions. In some embodiments, the clips 408 can be self-mounting. As shown, the clip 408 can be rotatably attached to the housing 402. In some embodiments, a spring loaded hinge can be used so that the clip 408 remains in the closed unless a force is applied to it. Once a force is applied to the clip 408, the clip 408 can rotate outwards. The housing 402 can then be inserted into a desired position, such as in a ceiling of a building, and the clip 408 can be released. The clip 408 can then retain the housing 402 in the desired location. In some embodiments, the clip 408 can allow for precise alignment with a ceiling, even if the ceiling is not the same thickness all around. In some embodiments, more than one clip 408 can be used. For example, 1, 2, 3, 4, 5, or 6 clips can be used. In some embodiments, the clips 408 can be evenly spaced around the housing 402. In some embodiments, the clips 408 are not evenly spaced around the housing 402. In some embodiment, the clip 408 can have a rotation point about 1 1/16 inch from a bottom of the housing 402. FIGS. 5A-B further show a general location of where an illumination source 502 would fit within the lighting system 401.

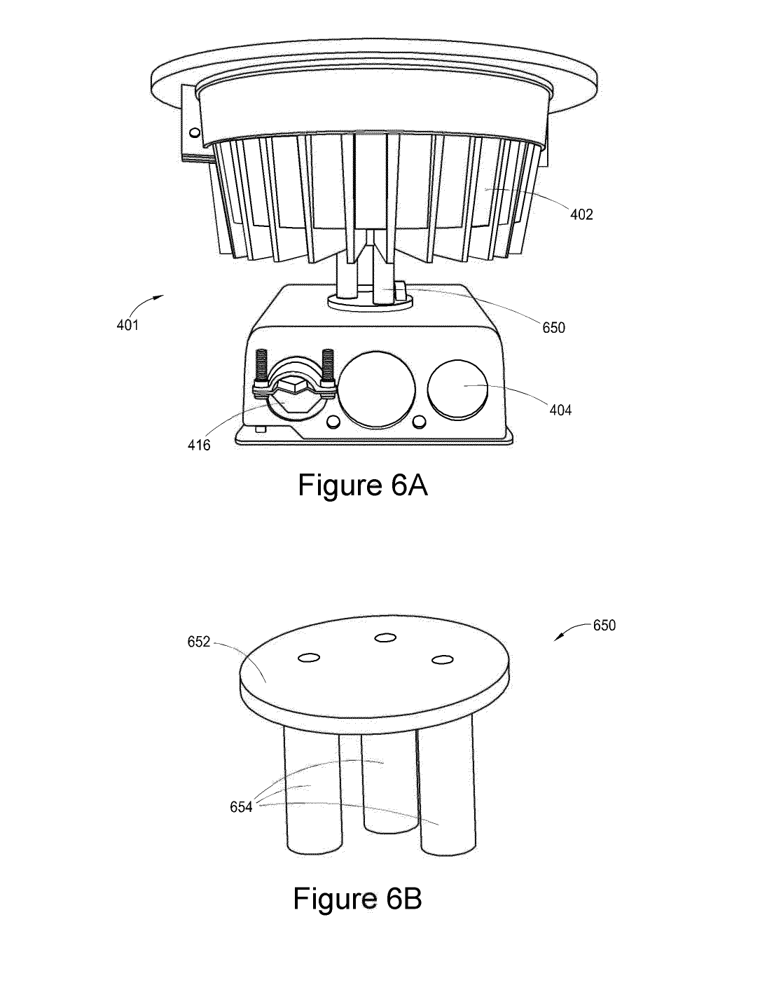

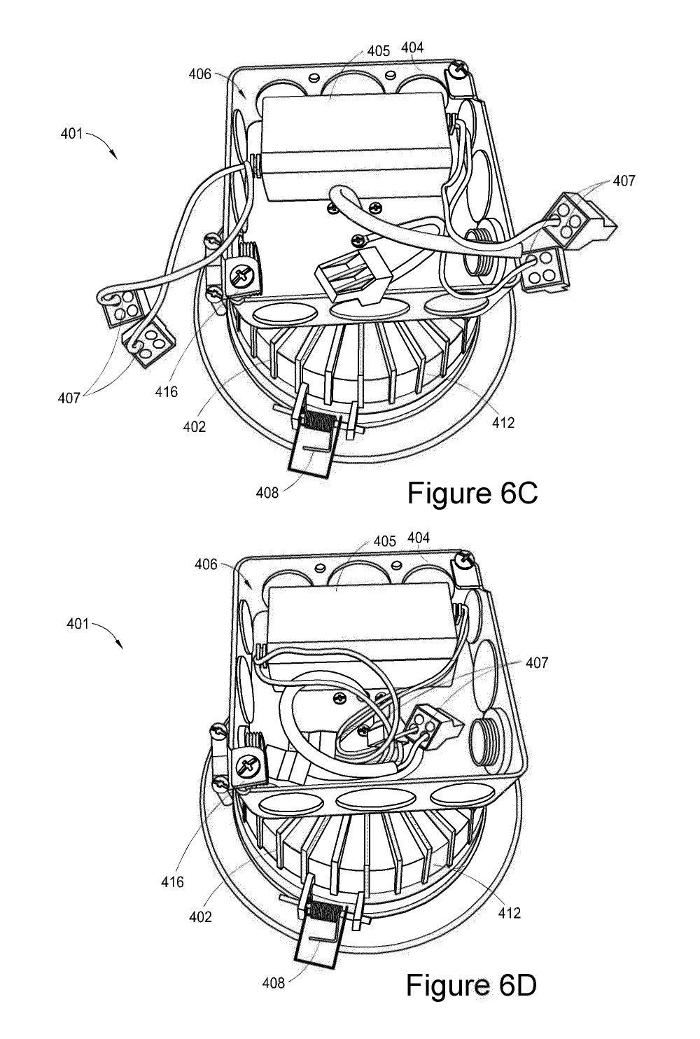

FIG. 6A-E illustrates an embodiment of a lighting system 400 having a spacer 650 located between the housing 402 and the junction box 404. The spacer 650 (shown alone in FIG. 6B) can generally have a disc-shaped end 652, though the particular dimensions of the disc-shaped end 652 do not limit the disclosure. Extending away from the disc-shaped end 652 are a plurality of legs 654, for example 1, 2, 3, 4, 5, or 6 legs, though the number of legs is not limiting. In some embodiments, the disc-shaped end 652 can have an aperture in which a cord can pass through, and the cord can pass between the plurality of legs 654. In some embodiments, the disc-shaped end 652 can be attached to the junction box 404 and the legs can be attached to the housing 402. The method of attachment does not limit the disclosure. In some embodiments, the spacer 650 position can be reversed. While a particular spacer 650 is discussed, other spacers can be used in order to provide separation between the junction box 404 and the housing 402.

In some embodiments, the height of the spacer can be greater than the height of the junction box 404. In some embodiments, the height of the spacer can be about 1.1, 1.2, 1.3, 1.4, 1.5, 1.6, 1.7, 1.8, 1.9, or 2 times greater than the height of the junction box 404. In some embodiments, the height of the spacer can be more than about 1.1, 1.2, 1.3, 1.4, 1.5, 1.6, 1.7, 1.8, 1.9, or 2 times greater than the height of the junction box 404.

In some embodiments, the height of the spacer can be less than the height of the junction box 404. In some embodiments, the height of the spacer can be about 0.1, 0.2, 0.3, 0.4, 0.5, 0.6, 0.7, 0.8, or 0.9 times less than the height of the junction box 404. In some embodiments, the height of the spacer can be less than about 0.1, 0.2, 0.3, 0.4, 0.5, 0.6, 0.7, 0.8, or 0.9 times less than the height of the junction box 404.

In some embodiments, the height of the spacer, from the bottom of the legs 654 to the top of the disc-shaped end 652 can be approximately the same as the height of the junction box 404.

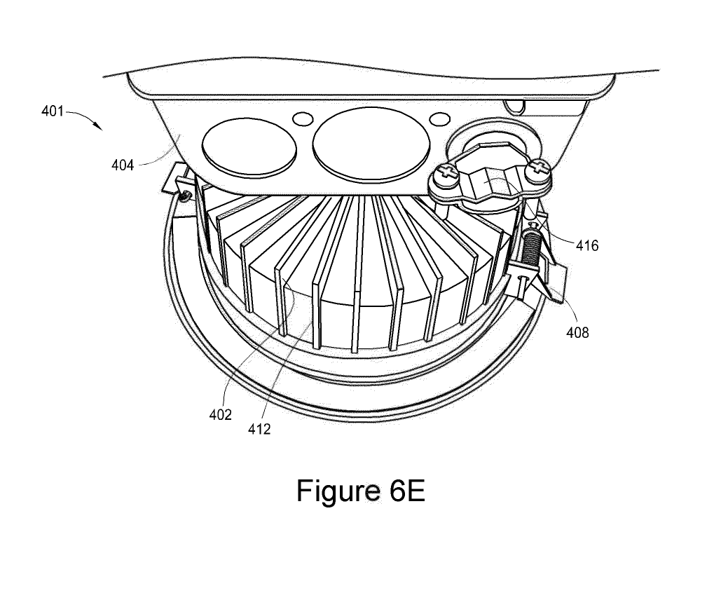

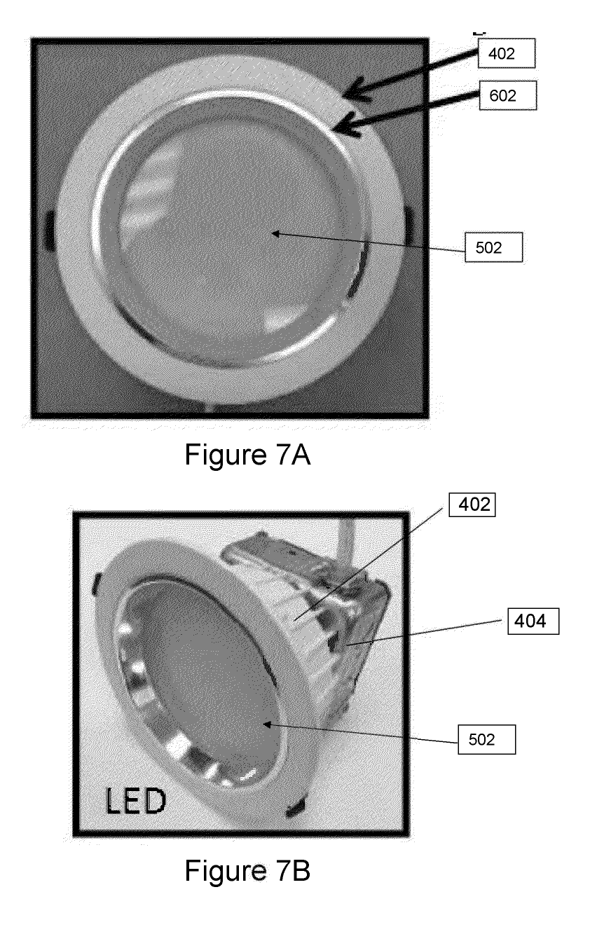

FIG. 7A illustrate a below viewpoint an embodiment of the disclosed lighting system 400 showing the illumination source 502. As shown, the illumination source 502 can be generally surrounded by a housing 402. The housing 402 can be generally bowl shaped, so that it can fit the illumination source 502 completely within the housing. In some embodiments, the illumination source 502 can protrude from the housing 402. In some embodiments, the illumination source 502 can extend outwards from the housing 402. In some embodiments, the illumination source 502 can extend to an edge of the housing 402. Further, the housing 402 can include a reflective portion 602 generally surrounding the illumination source 502, which can improve the amount of lighting that comes from the illumination source 502. The reflective portion 602 can be a number of different materials, such as metal, and the type of material does not limit the disclosure. FIG. 7B illustrates an angled viewpoint of an embodiment of the disclosed lighting system 400 so that the illumination source 502 and junction box 404 can both be seen.

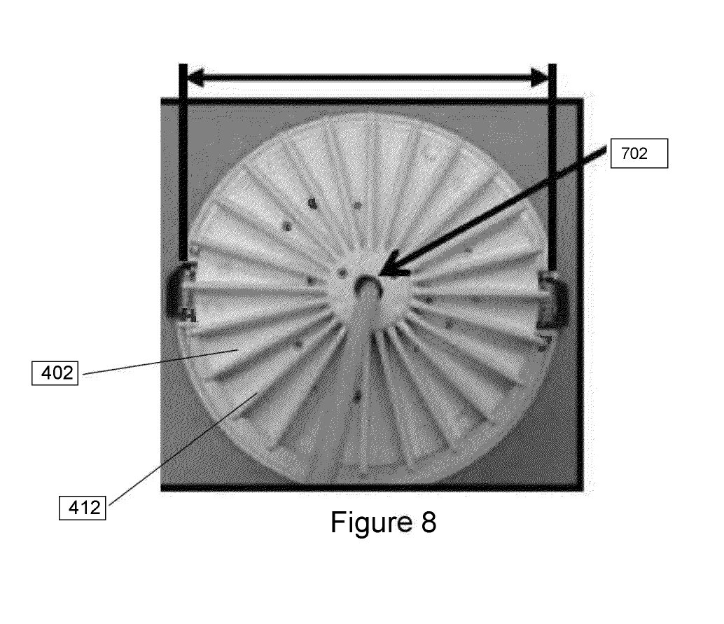

FIG. 8 illustrates the back of the housing 402 without the junction box 404. As shown, the fins 412 can extend onto the back side of the housing 402. Further, the back of the housing 402 can contain an aperture 702 where an electricity wire can pass through in order to provide power to the socket, and thus illumination source 502. The aperture 702 can align with an aperture 414 of the junction box 404.

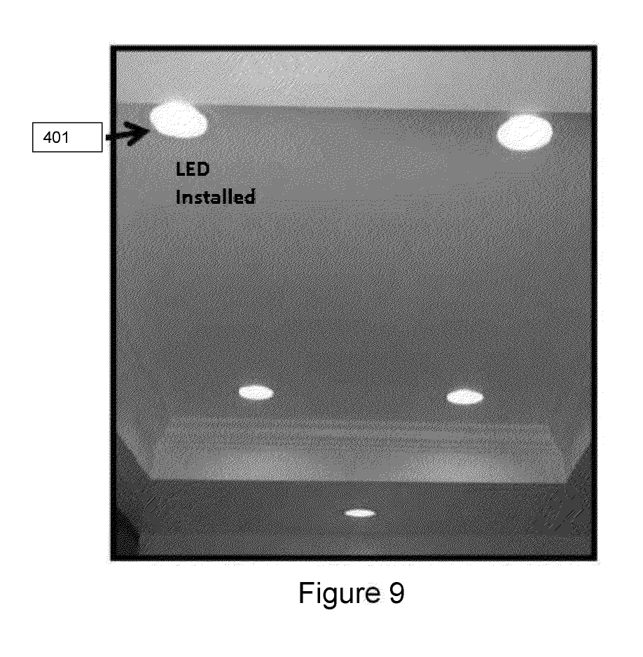

FIG. 9 shows an embodiment of the lighting assembly 401 installed in the ceiling of a building, though the lighting assembly 401 can be located in different locations as well, and the particular location of the assembly does not limit the disclosure. Further, as shown, a number of different lighting assemblies can be installed in one generally location to provide for more lighting. In some embodiments, different lighting assemblies 401 can be connected to one another so that they are all operable at the same time.

Method of Installation

Discussed herein as in example embodiment for installation of a lighting system 400, though other methods can be used as well, and the installation method does not limit the disclosure.

First, the desired location of the lighting assembly 401 on, for example, a ceiling, can be determined, though as discussed above different surfaces can be used as well. Then, a hole can be cut into the ceiling. The hole need only be slightly wider than the junction box 404, and need not be larger than the front side of the housing 402. In some embodiments, the hole can be about 4, 5, 6, 7, 8, 9, or 10 inches wide. In some embodiments, the hole can be less than about 4, 5, 6, 7, 8, 9, or 10 inches wide. In some embodiments, the hole can be less than the width of the lighting assembly 401. This is a significant advantage over the lighting systems of the prior art, as a substantially larger hole would need to be made to fit all of the pieces of the prior art lighting system.

Once the hole is cut, a cord can be pulled through the hole and attached into the junction box 404 of the lighting assembly 401. In some embodiments, the cover 409 of the junction box 404 can be removed for installation and replaced upon installation of the cord. The cover 409 can then be reattached. Next, the clips 408 can be moved into the open position, as shown in FIG. 5A, and the entire lighting assembly 401 can be inserted into the hole in the ceiling. The clips 408 can self align with the hole, thus putting the lighting assembly 401 in the proper position, and will hold the assembly 401 in place.

Advantages of Embodiments of the Disclosed Canless Lighting System

Embodiments of the disclosed lighting system 400 can provide for numerous and significant advantageous benefits over the lighting systems of the prior art.

For example, embodiments of the disclosed lighting system 400 can have an illumination lifetime of approximately 50,000, 70,000, 90,000, 100,000, 120,000, 140,000 or 150,000 hours. In some embodiments, the disclosed lighting system 400 can have an illumination lifetime of greater than approximately 50,000, 70,000, 90,000, 100,000, 120,000, 140,000 or 150,000 hours. In contrast, the above described can lighting systems of the prior art only have a lifetime of 30,000 hours. Thereby, the lifetime of embodiments of the lighting system 400 can be about 2×, 3×, 4×, or 5× greater. In some embodiments, the lifetime of embodiments of the lighting system 400 can be greater than about 2×, 3×, 4×, or 5× than the prior art lighting system. This may be due to the fact that the disclosed lighting system 400 can experience significantly less heat than the prior art lighting system, due at least in part to the removal of the can.

Further, embodiments of the lighting system 400 can be constructed as a single unit. This can allow for builders, as well as homeowners, to easily purchase and install the lighting system 400. This can be significantly advantageous over the prior art lighting systems, which can involve the purchase of many different parts, all of which need to installed together before complete installation of the lighting system.

Moreover, embodiments of the lighting system 400 can use significantly less parts than that of the prior art lighting system. For example, the lighting system 400 can use 2×, 3×, 4×, 5×, or 6× less parts. In some embodiments, the lighting system 400 can use greater than 2×, 3×, 4×, 5×, or 6× less parts.

In some embodiments, the lighting system 400 can have a much lower profile, or footprint, than that of the prior art lighting systems. For example, the profile of the disclosed lighting system 400 can be about 10, 20, 30, 40, 50, 60, or 70% less than the lighting system of the prior art. In some embodiments, the profile of the disclosed lighting system 400 can be greater than about 10, 20, 30, 40, 50, 60, or 70% less than the lighting system of the prior art. In some embodiments, the profile of the disclosed lighting system 400 can be less than about 10, 20, 30, 40, 50, 60, or 70% less than the lighting system of the prior art.

Additionally, in some embodiments the lighting system 400 can have a reduced height as compared to the prior art lighting system. In some embodiments, the prior art lighting system can have a height of about 2, 3, 4, 5, or 6 times greater than the disclosed lighting system 400. In some embodiments, the prior art lighting system can have a height of greater than about 2, 3, 4, 5, or 6 times greater than the disclosed lighting system 400. In some embodiments, the prior art lighting system can have a height of less than about 2, 3, 4, 5, or 6 times greater than the disclosed lighting system 400.

Therefore, embodiments of the lighting system 400 are not restricted to a specific space, unlike the prior art lighting system. Embodiments of the lighting system 400 can be located close to a wall or joint, whereas the wing arm or the rails of the prior art lighting system would not allow this. Further, as mentioned above, embodiments of the disclosed lighting system 400 are significantly more maneuverable than the prior art lighting system. By having a much smaller size and footprint, embodiments of the disclosed lighting system 400 can be installed in locations that would be nearly impossible for the prior art lighting system. This can allow for a user to have more choice in where to install a lighting system. Accordingly, the lighting system 400 is significantly more flexible in terms of installation location.

Compliance Requirements

Embodiments of the disclosed lighting system can meet with UL 8750—Light Emitting Diode Equipment for Use in Light Products, as well as UL 1598 & CSA C22.2 No. 250.0-08—Luminaires, the entirety of each of which is hereby incorporated by reference in its entirety. Further, embodiments of the disclosure have been certified with the California Energy Commission.

From the foregoing description, it will be appreciated that an inventive product and approaches for lighting systems are disclosed. While several components, techniques and aspects have been described with a certain degree of particularity, it is manifest that many changes can be made in the specific designs, constructions and methodology herein above described without departing from the spirit and scope of this disclosure.

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be depicted in the drawings or described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than or equal to 10% of, within less than or equal to 5% of, within less than or equal to 1% of, within less than or equal to 0.1% of, and within less than or equal to 0.01% of the stated amount.

Some embodiments have been described in connection with the accompanying drawings. The figures are drawn to scale, but such scale should not be limiting, since dimensions and proportions other than what are shown are contemplated and are within the scope of the disclosed inventions. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, it will be recognized that any methods described herein may be practiced using any device suitable for performing the recited steps.

While a number of embodiments and variations thereof have been described in detail, other modifications and methods of using the same will be apparent to those of skill in the art. Accordingly, it should be understood that various applications, modifications, materials, and substitutions can be made of equivalents without departing from the unique and inventive disclosure herein or the scope of the claims.

What is claimed is:

1. A lighting system comprising:
a housing configured to hold at least one source of illumination at a front end of the housing;
a junction box having a closed end supported by a back end of the housing opposite the front end, the junction box holding at least one electronic component for operating the source of illumination; and
a transformer supported by the housing;
wherein the housing and junction box are not covered by a can.

2. The lighting system of claim 1, further comprising at least one clip rotatably attached to the housing.

3. The lighting system of claim 2, wherein the at least one clip is spring mounted to the housing.

4. The lighting system of claim 1, wherein there is no separate arm attached to the housing.

5. The lighting system of claim 1, wherein there is no mounting slide configured to attach to the housing.

6. The lighting system of claim 1, wherein the housing has a generally circular cross section.

7. The lighting system of claim 1, wherein the at least one source of illumination comprises at least one LED.

8. The lighting system of claim 1, wherein the junction box is open opposite the closed end.

9. The lighting system of claim 1, wherein the transformer comprises a hot potted transformer.

10. The lighting system of claim 1, wherein the housing comprises at least one fin extending radially away from the base portion.

11. The lighting system of claim 1, further comprising a spacer located between and attached to the housing and junction box.

12. The lighting system of claim 1, wherein the lighting system has a total height of 5 inches or less.

13. The lighting system of claim 1, wherein the junction box comprises a plurality of walls extending from the closed end to the back end and configured to hold the electronic components.

14. The lighting system of claim 13, wherein the plurality of walls comprises at least one cord retainer configured to accept and retain a cord.

15. The lighting system of claim 1, wherein the housing comprises a baffled surface.

16. The lighting system of claim 1, wherein the housing comprises a reflector surface.

17. The lighting system of claim 1, wherein said housing is spaced from any radially surrounding structure having vertical surrounding metal walls by at least 12 inches.

18. A lighting system comprising:
a housing configured to hold at least one source of illumination at a front end of the housing; and
a junction box having a closed end supported by a back end of the housing opposite the front end, the junction box holding a transformer for operating the source of illumination.

19. The lighting system of claim 18, wherein the housing and junction box are not covered by a can.

20. A method of installing a lighting system into a building, the method comprising:
cutting an aperture in a building surface;
attaching a lighting system to a power source in the building, the lighting system comprising:
a housing configured to hold at least one source of illumination at a front end of the housing;
a junction box having a closed end supported by a back end of the housing opposite the front end, the junction box holding at least one electronic component for operating the source of illumination; and
a transformer supported by the housing;
wherein the housing and junction box are not covered by a can; and
inserting the housing, transformer, and junction box into the aperture, wherein the housing, transformer, and junction box are located within the aperture or behind the building surface.
